(19) United States
(12) Patent Application Publication
(10) Pub. No.: US 2013/0017471 A1
(43) Pub. Date: Jan. 17, 2013

(54) FUEL CELL WITH SELECTIVELY CONDUCTING ANODE COMPONENT

(71) Applicants: Herwig Haas, Surrey (CA); Joy Roberts, Coquitlam (CA); Francine Berretta, Vancouver (CA); Amy Shun-Wen Yang, Port Coquitlam (CA); Yvonne Hsieh, Burnaby (CA); Guy Pepin, North Vancouver (CA); Andrew Leow, Delta (CA); Richard Fellows, Vancouver (CA); Nicolae Barsan, Tubingen (DE)

(72) Inventors: Herwig Haas, Surrey (CA); Joy Roberts, Coquitlam (CA); Francine Berretta, Vancouver (CA); Amy Shun-Wen Yang, Port Coquitlam (CA); Yvonne Hsieh, Burnaby (CA); Guy Pepin, North Vancouver (CA); Andrew Leow, Delta (CA); Richard Fellows, Vancouver (CA); Nicolae Barsan, Tubingen (DE)

(73) Assignees: FORD MOTOR COMPANY, Dearborn, MI (US); DAIMLER AG, Stuttgart (DE)

(21) Appl. No.: 13/518,435

(22) PCT Filed: Dec. 22, 2010
(86) PCT No.: PCT/EP2010/007857

§ 371 Date: Sep. 26, 2012

Related U.S. Application Data
(60) Provisional application No. 61/289,203, filed on Dec. 22, 2009.

(51) Int. Cl. H01M 8/10; H01M 8/00

(52) U.S. Cl. 429/492; 429/535; 29/623.5

(57) ABSTRACT

To reduce degradation of a solid polymer fuel cell during startup and shutdown, a selectively conducting component is incorporated in electrical series with the anode components in the fuel cell. The component is characterized by a low electrical resistance in the presence of hydrogen or fuel and a high resistance in the presence of air. High cathode potentials can be prevented by integrating such a component into the fuel cell. A suitable selectively conducting component can comprise a layer of selectively conducting material, such as a metal oxide.

### FIELD OF THE INVENTION

The present invention pertains to fuel cells, particularly to solid polymer electrolyte fuel cells, and the components used in making such cells.

### BACKGROUND OF THE INVENTION

During the start-up and shut-down of fuel cell systems, corrosion enhancing events can occur. In particular, air can be present at the anode at such times (either deliberately or as a result of leakage) and the transition between air and fuel in the anode is known to cause temporary high potentials at the cathode, thereby resulting in carbon corrosion and platinum catalyst dissolution. Such temporary high cathode potentials can lead to significant performance degradation over time. It has been observed that the lower the catalyst loading, the faster the performance degradation. The industry needs to either find more stable and robust catalyst and cathode materials or find other means to address the performance degradation.

A number of approaches for solving the degradation problem arising during start-up and shutdown, which is a key obstacle in the commercialization of Polymer Electrolyte Membranes (PEM) with lower catalyst loadings, have been suggested. The problem has been addressed so far by higher catalyst loadings, valves around the stack to prevent air ingress into the anode while stored, and carefully engineered shutdown strategies. Some systems incorporate an inert nitrogen purge and nitrogen/oxygen purges to avoid damaging gas combinations being present during these transitions. See for example U.S. Pat. No. 5,013,617 and U.S. Pat. No. 5,045,414. Some other concepts involve case startup strategies with fast flows to minimize potential spikes. See for example U.S. Pat. No. 6,858,336 and U.S. Pat. No. 6,887,599. Many other concepts have been proposed.

Still, a more efficient, simple and cost effective method needs to be developed for the industry to overcome the degradation problem.

In the prior art, various coatings for cell components or additional layers in the cell assembly have been suggested in order to address other problems. For instance, US2006/0134501 discloses the use of an electro-conductive coating layer to cover the surface of a metal substrate on which reactant flow pathways are formed. This layer may include a metal oxide and preferably has excellent electrical conductivity characteristics. The coated separator however is considered not to perform and is unsuitable if the electrical conductivity is too low.

### SUMMARY OF THE INVENTION

Provided is a selectively conducting component for a solid polymer electrolyte fuel cell. The fuel cell comprises a solid polymer electrolyte, a cathode, and anode components connected in series electrically, in which:
i) the anode components comprise an anode and the selectively conducting component;
ii) the selectively conducting component comprises a selectively conducting material; and
iii) the electrical resistance of the selectively conducting component in the presence of hydrogen is more than 100 times lower, and preferably more than 1000 times lower, than the electrical resistance in the presence of air.

With such a component at the anode, temporary high cathode potentials can be prevented during startup and shutdown. Thus, incorporating the selectively conducting component in electrical series with the anode components represents a method for reducing degradation of a solid polymer fuel cell during startup and shutdown.

The selectively conducting material used in the component can be a metal oxide, preferably tin oxide, silica dispersed tin oxide, indium oxide/tin oxide, hydrated tin oxide, zirconium oxide, cerium oxide, titanium oxide, molybdenum oxide, indium oxide, niobium oxide or combinations thereof, and most preferably tin oxide, silica dispersed tin oxide, or indium oxide/tin oxide.

To improve the properties of a component comprising a metal oxide, it can be advantageous to include a noble metal close to the metal oxide. In particular, the noble metal can be deposited on the metal oxide, or alternatively doped within the metal oxide. Suitable noble metals include platinum, palladium, or platinum/antimony.

A particularly suitable selectively conducting material is platinum deposited tin oxide. The amount of platinum deposited on the tin oxide can be between 0.1% and 5% by weight. Improved properties have been observed when the amount of platinum deposited on the tin oxide was about 1% by weight.

The selectively conducting component may comprise a layer of the selectively conductive material. For various reasons, other materials may be included in the layer, such as an amount of a noble metal (as mentioned above) or a binder (such as a fluorinated or perfluorinated polymer, for instance polytetrafluoroethylene).

While the layer of selectively conductive material may extend over the entire active surface of the anode, there may also be advantages to extending over only a portion of the active surface of the anode. For instance, having areas where the layer of selectively conductive material is absent may allow for dissipation of reversal currents or provide a sacrificial area in the event of cell reversal. Embodiments possibly serving this purpose include one in which the layer of the selectively conductive material is absent in the vicinity of the anode inlet over more than 10% of the active surface of the anode and/or is absent in the vicinity of the anode outlet over more than 10% of the active surface of the anode. Further, the layer of the selectively conductive material may instead comprise a plurality of discrete selectively conductive regions, such as a stripe or plurality of stripes extending across the active surface of the anode. Further still, in a fuel cell stack comprising a plurality of stacked fuel cells (a typical commercial embodiment), the layer of selectively conductive material may be entirely absent in certain cells altogether (e.g. every other cell in the stack). Since corrosion loop currents usually go through all the cells in a stack, blocking the current locally may impact neighbouring cells as well.

A layer of selectively conducting material can be incorporated in numerous ways within the anode components of a fuel cell. For instance, the layer may be part of the anode and thus the selectively conducting component is the anode itself. The layer may be located on the side of the anode opposite the solid polymer electrolyte.

Alternatively, in fuel cells employing an anode gas diffusion layer adjacent the anode, the selectively conducting component may be the anode gas diffusion layer itself with the layer of the selectively conducting material incorporated on either side of the anode gas diffusion layer, i.e. the side adjacent the anode or the side opposite the anode.

Further, in fuel cells additionally employing an anode flow field plate adjacent the anode gas diffusion layer, the selectively conducting component may be the anode flow field plate itself with the layer of the selectively conducting material incorporated on the side of the anode flow field plate adjacent the anode gas diffusion layer.

Further still, it is instead possible to employ a discrete selectively conducting layer within the series connected anode components. In such a case, the selectively conducting component is the discrete selectively conducting layer. Such a discrete layer may be provided between the anode and an anode gas diffusion layer, or between an anode gas diffusion layer and an anode flow field plate.

A selectively conducting component can be made for instance by preparing a solid-liquid dispersion of the selectively conductive material, preparing a layer of the selectively conductive material from the dispersion, and then incorporating the layer of the selectively conductive material into the selectively conducting component. The latter can be accomplished by directly coating the dispersion on one of the anode, an anode gas diffusion layer, and an anode flow field plate, or alternatively by coating the dispersion onto a release film and then applying the coating on the release film under elevated temperature and pressure to one of the anode, an anode gas diffusion layer, and the anode flow field plate.

### BRIEF DESCRIPTION OF THE FIGURES OF THE DRAWINGS

FIG. 1 shows a schematic exploded view of the various components making up a unit cell for a solid polymer electrolyte fuel cell.

FIGS. 2a-e show a series of schematic views for exemplary anode gas diffusion layers coated with a selectively conducting layer but having uncoated regions for performance, cell reversal, or other purposes.

FIG. 3 shows plots of resistance versus time for several discretely prepared selectively conducting layers of the Examples while alternately exposing them to hydrogen and air.

FIG. 4 compares plots of voltage versus number of startup/shutdown cycles of several inventive fuel cells in the Examples to that of a comparative fuel cell.

FIG. 5 compares plots of voltage versus current density, both before and after subjecting to numerous startup/shutdown cycles, of an exemplary inventive fuel cell in the Examples to that of a comparative fuel cell.

### DETAILED DESCRIPTION OF THE PREFERRED EMBODIMENTS

A solid polymer electrolyte fuel cell stack for generating electricity at useful voltages generally includes several to many unit cells stacked in multi-layers. Each unit cell is formed with a membrane-electrode assembly (MEA) comprising an anode, sometimes referred to as a fuel electrode or an oxidation electrode, and a cathode, sometimes referred to as an air electrode or a reduction electrode, connected by means of a solid polymer electrolyte membrane between them. Both the anode and the cathode comprise appropriate catalysts (e.g. Pt) to promote the electrochemical reactions taking place therein. Porous, electrically conductive, gas diffusion layers (GDLs) are often employed adjacent the electrodes for purposes of distributing reactants to and by-products from the electrodes. And electrically conductive flow field plates comprising a plurality of channels patterned therein are often employed to evenly distribute reactants to, and by-products from, the adjacent GDLs. The flow field plates can serve as a separator between fuel cells in series and are thus sometimes referred to as a bipolar plate.

Hydrogen fuel is supplied to the anode and adsorbed on the anode catalyst, often present in the form of a catalyst coating on the membrane electrolyte (the assembly being known as CCM) on the anode. The fuel is oxidized to produce protons and electrons. The electrons are transferred to the cathode via an external circuit, and the protons are transferred to the cathode through the polymer electrolyte membrane. An oxidant, typically air, is supplied to the cathode, and the oxidant, protons and electrons are reacted on the catalyst present on or in the cathode to product electricity and water.

It has been found that the presence of a selectively conducting anode component according to the present invention integrated into the unit cell in series electrically with the other anode components can allow one to avoid severe degradation problems that can arise from repeated startup and shutdown of the fuel cell. The transient high cathode potentials which can occur at these times can be avoided via the presence of the selectively conducting component. The selectively conducting component may be an appropriately located selectively conducting layer comprised of a metal oxide that exhibits a low resistance when the gas environment around the layer is hydrogen or fuel, and a high resistance when air is the gas environment. The layer can be applied to the GDL or CCM, or in between. The layer should be porous when applied to the GDL or CCM. If applied to a flow field or bipolar plate, it need not be porous. The layer can also be dispersed throughout the GDL.

Materials Selection

The materials useful as the selectively conducting material and which exhibit the foregoing properties are primarily metal oxides such as tin oxide which are known to exhibit such properties in certain gas sensor applications. In the presence of hydrogen, such materials become more electrically conductive with a conduction path being created by an oxygen deficient structure at the surface. In the presence of oxygen, the materials convert to a stoichiometric state and become non-conductive.

Useful materials may include tin oxide (SnO₂₋ₓ), silica dispersed tin oxide (Silica-SnO₂₋ₓ), indium oxide/tin oxide (ITO), hydrated tin oxide, zirconium oxide (ZrO₂₋ₓ), cerium oxide (CeO₂₋ₓ), titanium oxide (TiOₓ), molybdenum oxide (MoOₓ), indium oxide (In₂Oₓ), niobium oxide (NbO₂) or combinations thereof, where x is a valence appropriate for the particular metal employed. Both stoichiometric and non-stoichiometric ratios are applicable. To date, tin oxide, silica dispersed tin oxide, or indium oxide/tin oxide have been found to be most preferable. But other metal oxides exhibiting some suitable level of conductivity may also be contemplated, including both n and p type oxides, such as but not limited to, WOₓ, NiOₓ, Cr₂Oₓ, ZnO, Ga₂Oₓ, BaSnOₓ, CuOx, Al₂Ox, Bi₂Oₓ, Fe₂Oₓ, CdOₓ, SrGeₓ, Co_{y}Oₓ, Ag₂Oₓ, CrTiO, V₂Oₓ, Ta₂Oₓ, La₂Oₓ, BaOₓ, Sb₂Oₓ, PdOₓ, CaOₓ, Cr₂Oₓ, Mn₂Oₓ, SrOₓ, and Nd₂O₃ where x is a valence appropriate for the particular metal of interest. Further still, useful materials can also include ternary, quaternary and complex metal oxides such as perovskites, niobates, tantalates, stannates and manganates. Mixtures of the oxide can also be used. Any appropriate combination can be used. Layers of the oxides or different oxides in different layers and/or multiple layers can also be used.

The metal oxides used can be pure oxides or have an amount of noble metal associated therewith. The presence of a suitable noble metal can be used to control the base resistance to an extent but also can be expected (via dissociation of adsorbed species) to enhance sensitivity, response times, stability or hydrogen selectivity, and decrease interference from other gases present, such as water vapour or CO, and thereby change operating characteristics including magnitude of resistance change, “switching time”, and maximum response operating temperature. In particular, enhancing sensitivity can be desirable because it can be difficult to achieve significant reactivity for a selected metal oxide under the conditions typically experienced in a solid polymer electrolyte fuel cell (i.e. at relatively low temperatures under 100° C. and high humidity conditions). In general, the reactivity of metal oxides is significantly improved at higher temperatures around 200-750° C. and high humidity conditions can tend to passivate gas sensing ability.

Noble metals may be incorporated with a suitable metal oxide by way of deposition thereon or alternatively by doping the metal oxide with the noble metal. Further still, noble metal may be provided instead by way of a separate layer intimately contacting the metal oxide. Suitable noble metals include platinum (Pt), palladium (Pd) and platinum/antimony (PtSb). The amount incorporated can be varied to achieve maximum functionality but would not be expected to exceed 30 wt % and preferably is less than 5%.

Other materials may also be incorporated with the metal oxide for similar or other purposes. Such materials may include PdO, Au, Ru, Rh, Ag, as well as Sn, In, Cu, Ir, Si, Si compounds, Sb, V, Mo, Al, Ta, Nb, Ge, Cr, Bi, Ga, Li, Ce, La, Y, Fe and Co. Silica for instance may be incorporated to improve selectivity (by helping the surface stay dry) for the fuel of interest. In the Examples below, a silica containing sample was used in part because it was present in a commercially available SnO₂ sample having a desired particle size.

Consideration should be given to the possibility that certain species may leach out into the MEA and act as contaminants that degrade MEA performance. Species such as iron, copper, chromium, zinc, vanadium, titanium and chloride could for instance possibly act as contaminants.

Exemplary Fuel Cell and Selectively Conducting Layer Constructions

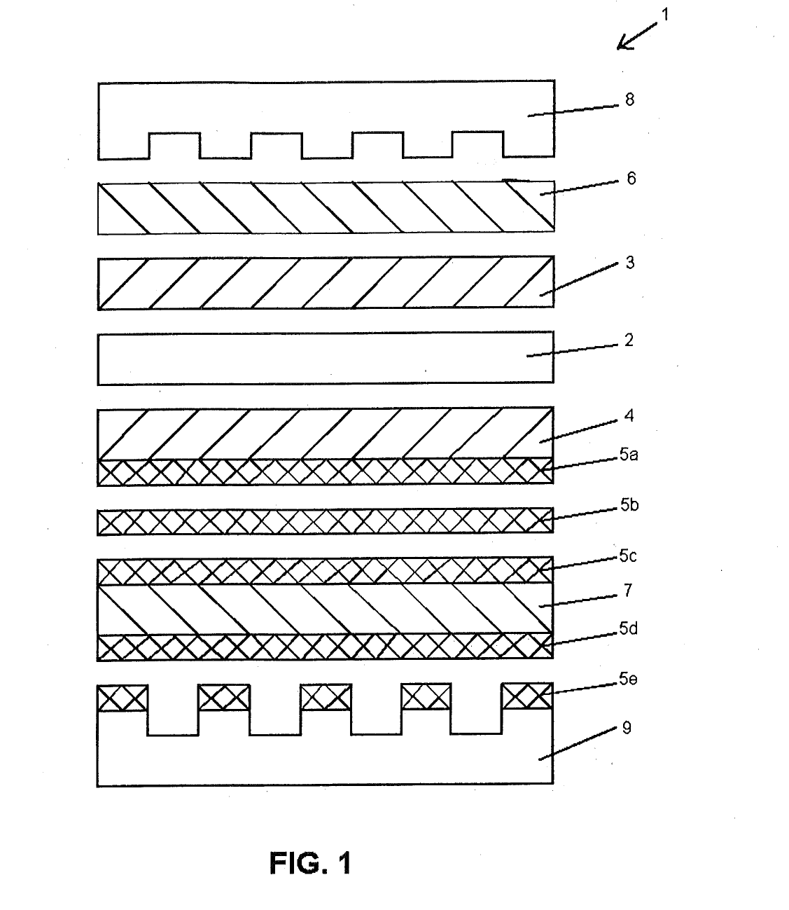

FIG. 1 shows an exploded schematic view of the various components making up a unit cell for a typical solid polymer electrolyte fuel cell and also some of the various locations that a selectively conducting layer of the invention might be incorporated. Unit cell 1 comprises a solid polymer electrolyte 2, cathode 3, and anode 4. Adjacent the two cathode and anode electrodes are cathode GDL 6 and anode GDL 7 respectively. Adjacent these two GDLs are cathode flow field plate 8 and anode flow field plate 9.

In accordance with the invention, a selectively conducting component is incorporated in electrical series with the anode components. As shown in FIG. 1, this selectively conducting component can be incorporated in one of the existing anode components or alternatively as a separate discrete layer. For instance, the selectively conducting component can be layer 5a which forms part of anode 4. Or, the selectively conducting component can be layer 5c or 5d which form part of anode GDL 7. Layer 5c is located on the side of anode GDL 7 which is adjacent anode 4. Layer 5d is located on the side of anode GDL 7 which is opposite anode 4 and adjacent anode flow field plate 9. Further, the selectively conducting component can be layer 5e which forms part of flow field plate 9 and is on the side adjacent anode GDL 7. While these various selectively conducting layers are shown as being on only one side of the components they are associated with in FIG. 1, the layers need not be on one side only. While perhaps not preferred, the layers may actually extend throughout the associated components. Further still, the selectively conducting layer can be a discrete layer 5b shown in FIG. 1 as being between anode 4 and anode GDL 7. Alternatively however, discrete layer 5b may instead be located between anode GDL 7 and anode flow field plate 9 (not shown in FIG. 1).

Layers like those illustrated in FIG. 1 may be prepared in a variety of ways. A preferred method starts with a solid-liquid dispersion of suitable ingredients and, using a suitable coating technique, applying a coating of the dispersion to a selected anode component. After application, the coated component is dried and optionally subjected to other post-treatment (e.g. sintering). Alternatively, coating techniques can be used to prepare discrete layers.

A dispersion for applying coatings in this manner will typically comprise an amount of selectively conducting metal oxide particles, one or more liquids in which the metal oxide particles are dispersed, and optionally other ingredients such as binders (e.g. ionomer, PTFE) and/or materials for engineering porosity or other desired characteristics in the selectively conducting component. Water is a preferred dispersing liquid but alcohols and other liquids may be used to adjust viscosity, to dissolve binders, and so forth.

Conventional coating techniques, such as Mayer rod coating, knife coating, decal transfer, or other methods known to those in the art, may be employed to apply dispersion onto or into a selected anode component. Alternatively, a coating may be applied to a release film, dried, and then applied under elevated temperature and pressure so as to bond to a selected anode component.

Discrete layers such as layer 5b may be prepared in a like manner by applying a coating onto or into a suitable substrate (e.g. soaking a glass fibre matrix, an expanded PTFE matrix, quartz filled filter nylon matting, or other substrate in dispersion, followed by drying and sintering). Alternatively discrete layers having similar compositions may be prepared completely from a suitable dispersion (e.g. in which the dispersion contains glass or other fibres). Use of a discrete selectively conducting oxide layer can permit several design options.

As mentioned above, although not shown In FIG. 1, the selectively conducting layer can extend through the anode component it is associated with. In the case of anode 4, anode catalyst may in principle essentially be supported on a suitable selectively conducting metal oxide layer. However, it may be advantageous to keep selectively conductive layer 5a separate from the anode catalyst. Because ionomer electrolyte is provided in the vicinity of the anode catalyst, dissolution and electrochemical stresses may be reduced by not allowing direct contact between the anode catalyst and the selectively conducting layer. A carbon sublayer may for instance be incorporated between the two for this purpose.

The properties of the selectively conducting layer, regardless of where and in what form it appears, need to be tailored to certain specific system needs. In particular, the layer has to be engineered so as to exhibit the different desired resistance characteristics such that it has acceptable conductance in the presence of hydrogen and yet is sufficiently resistive in the presence of oxygen (air). As is known in the prior art, layers or coating of metal oxides can be made that are always conductive or alternatively may not be conductive enough. Because the change in resistance with surrounding atmosphere is associated with changes at the surface of the metal oxide particles as opposed to the bulk, the choice of metal oxide material, its particle size and shape, the thickness and porosity of the fabricated layer, along with other variables are all important considerations. Layer thicknesses may for instance be expected in the range from about 1 μm to 300 μm. And particle sizes may be in the range of 10-25 nm with surface areas of 40 m²/g to 200 m²/g. Those skilled in the art will appreciate the variables involved and the interactions between them and are therefore expected to be able to design layers appropriately. The layer must have sufficient resistance to prevent local high voltages and reduce corrosion currents in practice during the startup and shutdown transitions. For certain commercial applications, modelling suggests for instance that good resistance targets may involve a three order of magnitude change in resistance, such as over 10⁻³ ohms/m² in air and less than 10⁻⁶ ohms/m² in hydrogen. Such targets have been demonstrated to be viable in the Examples to follow. Of course, other factors also must be considered by those skilled in the art. For instance, if the layer is embodied in the anode or anode GDL, it must be sufficiently porous to permit acceptable diffusion of the gases. The morphology of the layer, i.e. grain size, porosity, binders etc. will determine gas transfer properties then as well as resistance related characteristics. On the other hand, a layer (e.g. 5e) on the anode flow field plate may however be a solid coating.

While the preceding discussion is directed to use of a single selectively conducting layer, there may be advantages associated with using multiple layers of applied metal oxide (e.g. one coating may be of a less expensive material and another more expensive one but at a lower loading). An optional “filter” layer may be employed in addition in order to limit the amount of air reaching the selectively conducting metal oxide. This functionality may be combined for instance in the anode GDL.

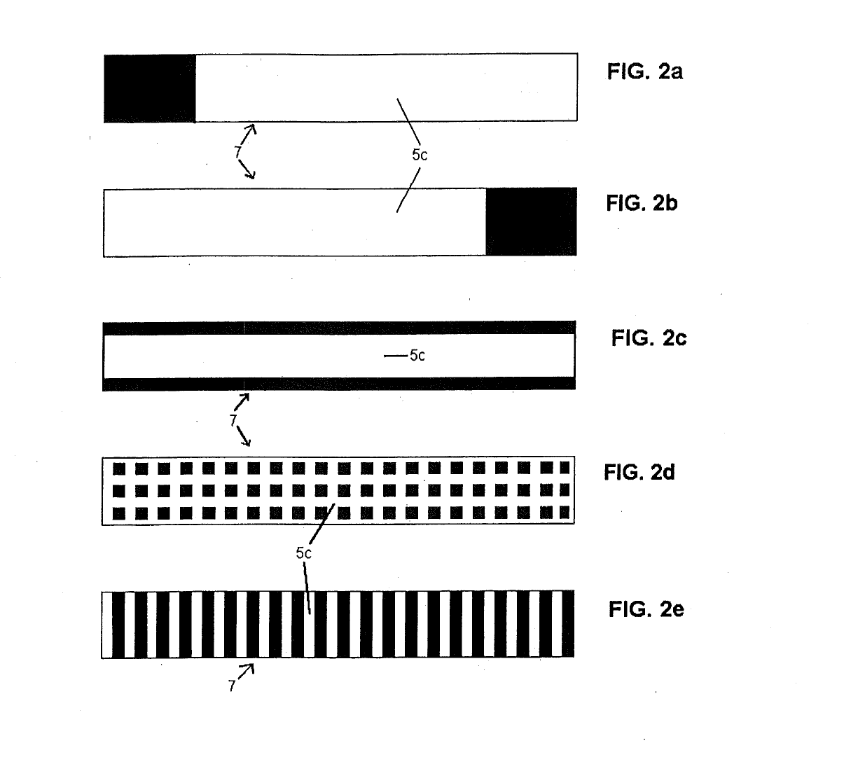

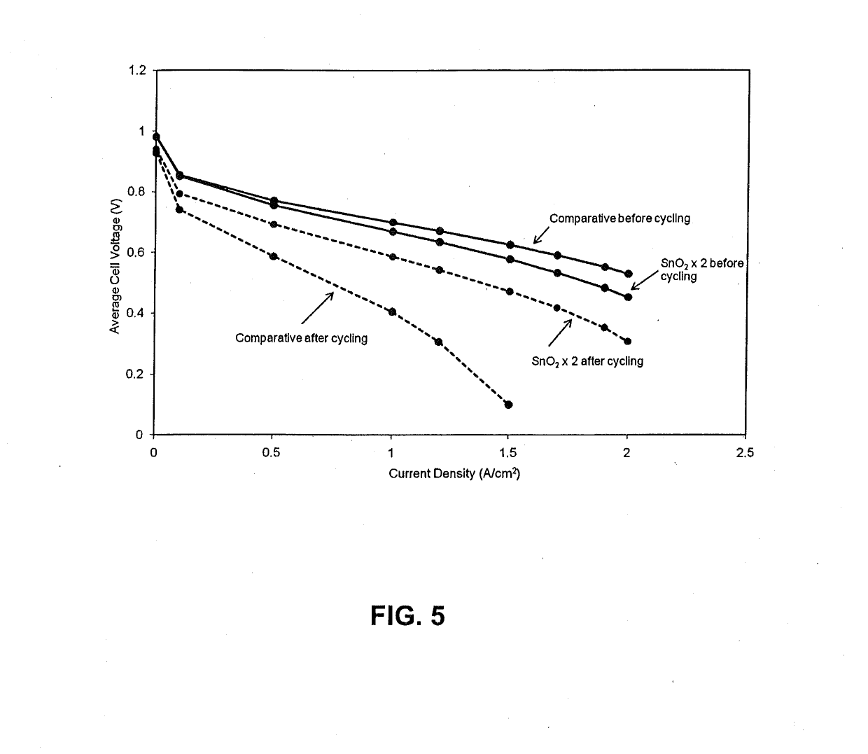

Incorporating a selectively conducting component at the anode can be advantageous in fuel cells with regards to degradation arising during startup/shutdown. However, the presence of such a component or layer can potentially lead to a loss in cell performance (due to an increase in internal resistance) and also may lower the tolerance of the fuel cell to voltage reversals. While a selectively conductive layer may therefore appear as a continuous layer over the entire active surface of the anode, it may be desirable to pattern the layer in order to mitigate these possible adverse effects. Providing some regions where the layer of selectively conductive material is absent may allow for dissipation of reversal currents and/or provide a sacrificial area in the event of cell reversal. FIGS. 2a-2e show various options available in this regard. FIG. 2a shows anode GDL 7 with coated layer of selectively conductive material 5c in which the coated layer is absent in the vicinity of the anode inlet (i.e. the left hand side of GDL 7 in FIG. 2a, wherein the coating is absent over about or more than 10% of the active surface of the anode). FIG. 2b shows an embodiment where the coated layer is absent in the vicinity of the anode outlet (i.e. the right hand side of GDL 7 in FIG. 2b, wherein the coating is absent over about or more than 10% of the active surface of the anode). FIG. 2c shows an embodiment comprising a stripe of selectively conducting layer 5c down the middle of GDL 7 with coating absent at the edges. FIG. 5d shows an embodiment wherein the uncoated regions of layer 5c appear as a pattern of uncoated squares. FIG. 2e shows an embodiment comprising a plurality of discrete selectively conductive stripes 5c extending across the active surface of the anode. Yet another option, not shown in FIGS. 2a-2e is the possibility of incorporating a selectively conducting layer in a graded structure. That is, the thickness of the layer and hence the resistance properties may be varied over the length of the active anode surface.

Further still, in a fuel cell stack comprising a plurality of stacked fuel cells (a typical commercial embodiment), the layer of selectively conductive material may be entirely absent in certain cells altogether (e.g. every other cell in the stack, every third cell, etc.). Since corrosion loop currents usually go through all the cells in a stack, blocking the current locally may impact neighbouring cells as well.

The use of the selective conducting material avoids severe degradation by avoiding high cathode potentials. Without being bound by theory, it is believed this is accomplished as follows. During startup and shutdown, air may be present at the anode as a result of leakage after prolonged storage or as part of a deliberate shutdown procedure. When a hydrogen wave enters a cell upon start-up, the cell voltage can rise from near 0 V to above 0.7 V and beyond. This voltage will be “forced” on the region of the cell outlet (air-air region) while the inlet area sees hydrogen at the anode and air at the cathode. Under these conditions, a substantial current (up to 0.1 A/cm²) can flow through the membrane electrode assembly (MEA) in the air-air region, forcing the cathode potential up and the anode potential down. However, if a high enough resistance is present in the air-air region (due to the presence of the selectively conducting layer), then the current in the air-air region will be substantially reduced and the high cathode potentials prevented. But such a high resistance is not desired during regular operation. The trigger to switch between the conducting mechanisms is the metal oxide gas sensitive selective layer of the present invention. The switching mechanism is fast (<10 sec and preferably <5 sec), easily reversible and is able to withstand thousands of cycles.

Use of the selective conducting material in a fuel cell allows the advantages of system simplification and cost reduction. Less additional system components are needed, i.e., isolation valves, shorting devices, etc. Catalyst loading reduction is simplified as durability stressors are turned off. Gas need not be wasted at startup from unnecessary purging, and specialty gases are not required.

In principle, fabrication of the selectively conducting component may be relatively simple and low cost and could be combined for instance with metal plate passivation steps. By decreasing the carbon corrosion and cathode catalyst degradation due to startup/shutdown degradation, lower catalyst loadings can be considered in MEA design. Another potential advantage offered is the ability to use less electrochemically stable materials such as PtCo, which are more sensitive to the fuel cell voltage cycling window.

Use of the invention is not limited just to fuel cells operating on pure hydrogen fuel but also to fuel cells operating on any hydrogen containing fuel or fuels containing hydrogen and different contaminants, such as reformate which contains CO and methanol.

The following Examples have been included to illustrate certain aspects of the invention but should not be construed as limiting in any way.

### EXAMPLES

Selectively Conducting GDL Component Preparation and Characterization

Several different metal oxide compositions were obtained in order to prepare solid-liquid dispersions for use in coating selectively conducting layers onto test GDL samples.

The metal oxide compositions obtained were:

SnO₂ obtained from SkySpring Nanomaterials Inc. and characterized by particle sizes between 50 and 70 nm and a surface area between 10 and 30 m²/g

1% Pt—SnO₂ which is a proprietary composition obtained from a commercial supplier and having the Pt deposited on the SnO₂

5% Pt—SnO₂ which is a proprietary composition obtained from a commercial supplier and having the Pt deposited on the SnO₂

Silica dispersed SnO₂ obtained from Keeling and Walker and characterized by particle sizes less than 5 micrometers and a surface area greater than 100 m²/g

ITO (indium tin oxide) obtained from several sources including SkySpring Nanomaterials Inc. and characterized by particle sizes generally between 20 and 70 nm and surface areas between 15 and 40 m²/g

hydrated SnO₂ (metastannic acid) obtained from Keeling and Walker and characterized by a surface area about 180 m²/g.

Solid-liquid ink dispersions were prepared using each of these various metal oxide compositions. The dispersions comprised mixtures of the selected metal oxide, METHOCEL™ methylcellulose polymer, distilled water, isopropyl alcohol, and optionally PTFE (polytetrafluoroethylene) suspension. The dispersions were all prepared first by manually mixing the components together, followed by sonication, and finally shear mixing with a Silverson mixer. The dispersions were then used to coat a conventional carbon fibre anode GDL from Toray using a Mayer rod with one or more passes of coating. In between passes, the coatings were allowed to air dry at ambient temperature and after all the passes were applied, the GDL samples were sintered at about 400° C. for ten minutes. The average thickness of the total coating applied was in the range from about 5-15 micrometers.

For initial screening purposes, small experimental fuel cells were made and initial polarization plots (cell voltage versus current density plots) were obtained using each coated GDL. These experimental fuel cells employed a conventional polymer electrolyte membrane coated with catalyst on both sides. To determine whether the coated GDL adversely affected fuel cell performance, experimental cells were assembled using the coated GDLs as an anode GDL and a conventional GDL as a cathode GDL. The coated anode GDL was then exposed to hydrogen and should thus desirably have a relatively low resistance. To determine whether the coated GDL might adequately protect against high transient cathode voltages, other experimental cells were assembled using the coated GDLs as a cathode GDL and a conventional GDL as an anode GDL. In these cases, the coated GDLs were exposed to air and should thus desirably have a relatively high resistance. (In the preceding experimental fuel cell constructions, the selectively conducting coated side of the GDL was located adjacent the appropriate electrode in the catalyst coated membrane assembly.)

In this testing, the experimental test cells using the GDLs coated with SnO₂, 1% Pt—SnO₂, and 5% Pt—SnO₂ exhibited the most promising voltage versus current density characteristics. All typically provided more than 0.7 V output at current densities up to 1.2 A/cm²when the selectively conducting GDLs were used at the anode and thus were exposed to hydrogen, while none could sustain 0.7 V output above 0.2 A/cm² when the GDLs were used at the cathode and thus were exposed to air. These coated GDLs therefore appeared most attractive for use as selectively conducting components. However, the other metal oxides and GDLs coated therewith exhibited similar results qualitatively and thus might still be expected to be suitable, especially with modifications to the particle size, dispersion mixture, and/or coating amount or other characteristics.

Further experiments were performed to determine effectiveness in preventing degradation in fuel cells subjected to startup/shutdown cycling. The following coated and comparative anode GDL samples were used:

TABLE 1

| | Metal oxide | # of | PTFE |
|---|---|---|---|
| Anode GDL | composition used | coating passes | binder present? |
| SnO₂ x1 | SnO₂ | 1 | Yes |
| SnO₂ x2 | SnO₂ | 2 | Yes |
| 1% Pt—SnO₂ x2 | 1% Pt—SnO₂ | 2 | No |
| 1% Pt—SnO₂ x4 | 1% Pt—SnO₂ | 4 | Yes |
| 5% Pt—SnO₂ x2 | 5% Pt—SnO₂ | 2 | No |
| Silica-SnO₂ | Silica-SnO₂ | 8 | Yes |
| Comparative | None | 0 | NA |

To get information on the actual resistance characteristics expected of the selectively conducting layer on these GDLs, resistance measurements were obtained on several related samples in a closed, environmentally controlled chamber. Coatings prepared in a like manner to some of the sample GDLs above were applied to Kapton polymer film. The in-plane resistances of the coated layers were determined by applying probes to the coating surface. The samples were 2.7 cm by 1.9 cm in size and the resistance was measured over the 1.9 cm dimension. The samples were then alternately exposed to hydrogen and air in the chamber while the in-plane resistance was recorded.

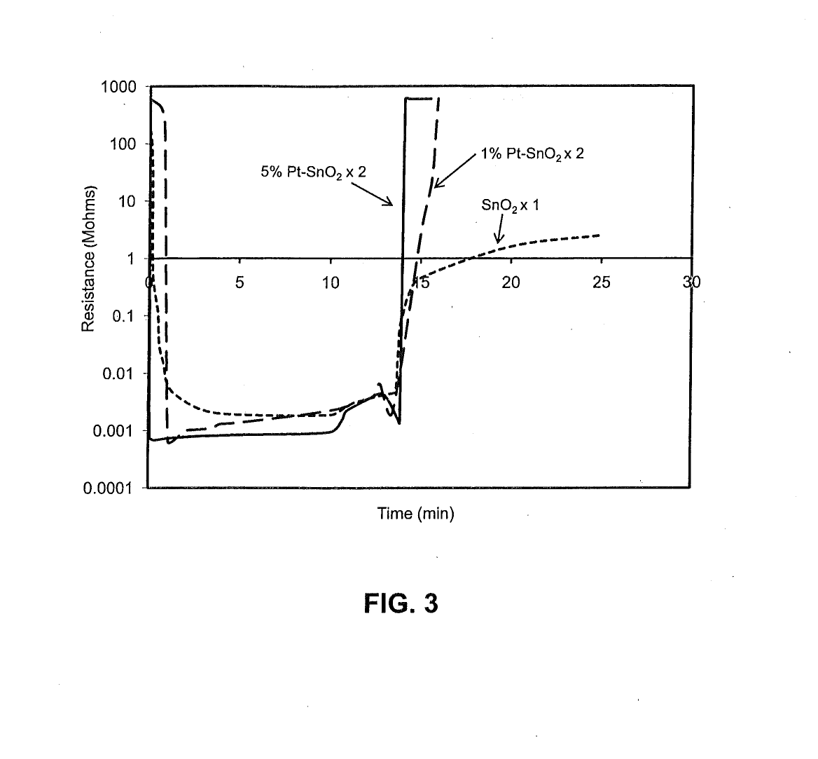

FIG. 3 shows plots of resistance versus time for three coatings similar to GDL samples SnO₂ ×1, 1% Pt—SnO₂ ×2, and 5% Pt—SnO₂ ×2 above. In FIG. 3, the first recorded points were taken with the coatings exposed to air as prepared. Immediately thereafter, the coatings were exposed to hydrogen and about 15 minutes later exposed back to air again. In all cases, the change in resistance was dramatic and relatively rapid. The Pt deposited tin oxide coatings changed resistance particularly rapidly and were characterized by up to a five orders of magnitude change in resistance (from over 100 ohm to almost 1 milliohm).

Preparation and Startup/Shutdown Testing of Fuel Cells Comprising Selectively Conducting Anode GDLs

A series of commercial size experimental fuel cells were made using the anode GDLs of Table 1. The same type of catalyst coated membrane electrolytes and conventional cathode GDLs were used as were used in the preceding test cells. Assemblies were stacked such that the selectively conducting layer of the anode GDLs were adjacent the anode catalyst coating on the membrane electrolyte. The assemblies were then bonded together under elevated temperature and pressure and placed between appropriate cathode and anode flow field plates to complete the fuel cell.

The cells were operated at a current density of 1.5 A/cm² using hydrogen and air reactants at 60° C. and 70% RH and were periodically subjected to startup/shutdown cycles designed to accelerate degradation. The cycling comprised removing the electrical load while maintaining the flow of reactants for 10 seconds, applying a load for 5 seconds to draw 0.7 A/cm², ramping the load over 30 seconds to draw 1.5 A/cm², removing the load for 5 seconds while maintaining the flow of reactants, purging the anode with air for 15 seconds, and repeating.

Voltage output of each cell was recorded after each startup/shutdown cycle. In addition, polarization characteristics (voltage as a function of current density) characteristics were obtained for the cells throughout the startup/shutdown cycle testing. It was observed that the fuel cell employing the silica dispersed SnO₂ based anode GDL produced a somewhat unstable voltage when operating at higher relative humidity and so is not reported on further. (This design would need modification for stable operation.) The other cells did not exhibit any voltage instability during testing.

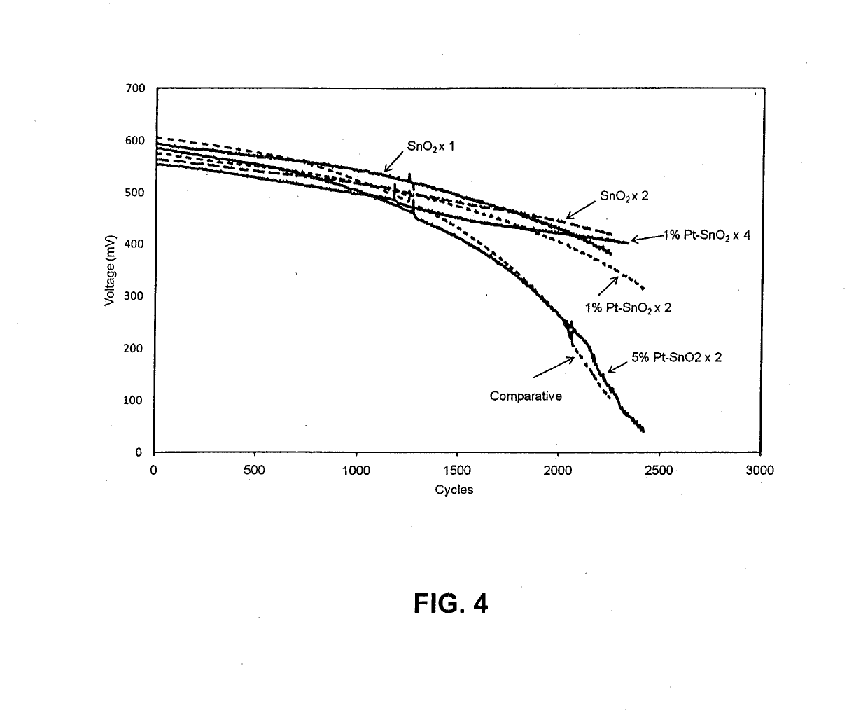

FIG. 4 compares plots of output voltage at 1.5 A/cm² versus number of startup/shutdown cycles for all the cells tested here. All the cells showed a slow degradation in voltage with cycle number. However, after about 1200 startup/shutdown cycles, the output voltage of the comparative cell and the cell with the 5% Pt—SnO₂ ×2 anode GDL started to drop dramatically when compared to that of the other test cells. After 2000 cycles, the former were unable to provide almost any output voltage. The other test cells employing selectively conducting anode GDLs were still able to sustain a substantial voltage output.

Polarization results for the various tested cells are summarized in Table 2 below. In this table, representative voltages before cycle testing are provided at a low current density (0.1 A/cm²) and at a high current density (1.5 A/cm²). Representative voltages at these current densities are also provided after 1667 startup/shutdown cycles. Also, Table 2 shows the average degradation rate observed after 1667 cycles for each cell (i.e. difference in voltage before and after cycling divided by the number of cycles). As is evident from this data, the presence of the selectively conducting layer in the test cells results in a modest reduction in output voltage before cycle testing is done. However, without an appropriate selectively conducting layer present, the output voltage is drastically reduced after cycling.

TABLE 2

| | Voltage | Voltage | | | |
|---|---|---|---|---|---|
| | in mV | in mV | | | Average |
| | at 0.1 | at 1.5 | Voltage in | Voltage in | degradation |
| | A/cm² | A/cm² | mV at | mV at | rate |
| | before | before | 0.1 A/cm² | 1.5 A/cm² | (mV/cycle) |
| Anode GDL | cycle | cycle | after 1667 | after 1667 | after 1667 |
| used | testing | testing | cycles | cycles | cycles |
| Comparative | 851-860 | 624 | 740 | 100 | 125.5 |
| SnO₂ x1 | 856 | 609 | 773 | 434 | 67.4 |
| SnO₂ x2 | 851 | 577 | 793 | 472 | 69 |
| 1% Pt—SnO₂ | 856 | 596 | 750 | 276 | 70.5 |
| x2 | | | | | |
| 1% Pt—SnO₂ | 852 | 534 | 808 | 437 | 71.4 |
| x4 | | | | | |

In the above table, voltage values relative to those of the comparative cell are provided in brackets for ease of comparison.

FIG. 5 shows exemplary polarization plots obtained for an inventive fuel cell (i.e. the cell made with the SnO₂ ×2 anode GDL) and the comparative fuel cell. Shown are plots of voltage versus current density, both before cycle testing began and after the cycle testing shown in FIG. 4 had finished.

After cycle testing, the cells were disassembled for post-mortem analysis. Sections of each cell were obtained from near the fuel inlet, at the middle and near the outlet, were then mounted in epoxy, and analyzed using a scanning electron microscope. Measurements were made of the relative amount of platinum found in the membrane electrolyte, the thickness of the carbon GDL, and the thickness of the selectively conducting layer remaining (where appropriate), and these were compared to the values observed in the freshly assembled cells.

The presence of Pt in the membrane is indicative of loss of cathode catalyst. The comparative cell showed little Pt in the inlet region but significant amounts in the middle and outlet regions. The membranes of all of the cells comprising selectively conducting layers showed less Pt than that of the comparative cell. In some cases, such as for the cells made with the silica-SnO₂ and the 5% Pt—SnO₂ ×4 anode GDLs, the difference was appreciable.

A reduction in thickness of the cathode catalyst would be indicative of carbon corrosion. No appreciable thinning was seen in any cell tested.

A reduction in thickness of the selectively conducting layer is indicative of loss which could be due to washing out of the applied layer. However, no significant changes were observed in these values after cycling.

From observations of the 1% Pt—SnO₂ ×2 anode GDL as made and after post-mortem analysis, it was believed to suffer from relatively poor coating and/or layer adhesion. This may explain the poorer than expected results associated with its use when compared to the other test cells. With regards to the 5% Pt—SnO₂ ×2 anode GDL, it is postulated that the 5% amount deposited in this particular embodiment may be too much.

Generally however, these examples show a marked improvement in degradation after extended startup/shutdown cycling for actual fuel cells comprising selectively conducting anode GDLs. No significant adverse effect on fuel cell performance was observed with the presence of the selectively conducting layer in these example cells.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1.-29. (canceled)

30. A selectively conducting component for a solid polymer electrolyte fuel cell, the fuel cell comprising a solid polymer electrolyte, a cathode, and anode components connected in series electrically, wherein:
i) the anode components comprise an anode and the selectively conducting component;
ii) the selectively conducting component comprises a selectively conducting material; and
iii) the electrical resistance of the selectively conducting component in the presence of hydrogen is more than 100 times lower than the electrical resistance in the presence of air.

31. The selectively conducting component of claim 30 wherein the electrical resistance of the selectively conducting component in the presence of hydrogen is more than 1000 times lower than the electrical resistance in the presence of air.

32. The selectively conducting component of claim 30 wherein the selectively conducting material is a metal oxide.

33. The selectively conducting component of claim 32 wherein the selectively conducting material is selected of a group consisting of tin oxide, silica dispersed tin oxide, indium oxide/tin oxide, hydrated tin oxide, zirconium oxide, cerium oxide, titanium oxide, molybdenum oxide, indium oxide, niobium oxide or combinations thereof.

34. The selectively conducting component of claim 32 wherein the selectively conducting material additionally comprises a noble metal deposited on the metal oxide.

35. The selectively conducting component of claim 32 wherein the selectively conducting material additionally comprises a noble metal doped within the metal oxide.

36. The selectively conducting component of claim 34 wherein the noble metal is platinum, palladium, or platinum/antimony.

37. The selectively conducting component of claim 34 wherein the selectively conducting material is platinum deposited on tin oxide and the amount of platinum deposited on the tin oxide is between 0.1% and 5% by weight.

38. The selectively conducting component of claim 30 wherein the selectively conducting component comprises a layer of the selectively conductive material.

39. The selectively conducting component of claim 38 wherein the layer of the selectively conductive material comprises a binder.

40. The selectively conducting component of claim 39 wherein the binder is selected from a group consisting of fluorinated polymer, perfluorinated polymer, and polytetrafluoroethylene.

41. The selectively conducting component of claim 38 wherein the layer of the selectively conductive material extends over only a portion of the active surface of the anode.

42. A solid polymer electrolyte fuel cell comprising the selectively conducting component of claim 30.

43. The solid polymer electrolyte fuel cell of claim 42 wherein the component is the anode and the layer of the selectively conducting material is on the side of the anode opposite the solid polymer electrolyte.

44. The solid polymer electrolyte fuel cell of claim 42 wherein the anode components comprise an anode gas diffusion layer adjacent the anode, the selectively conducting component is the anode gas diffusion layer, and the layer of the selectively conducting material is on the side of the anode gas diffusion layer adjacent the anode.

45. The solid polymer electrolyte fuel cell of claim 42 wherein the anode components comprise an anode gas diffusion layer adjacent the anode, the selectively conducting component is the anode gas diffusion layer, and the layer of the selectively conducting material is on the side of the anode gas diffusion layer opposite the anode.

46. The solid polymer electrolyte fuel cell of claim 42 wherein the anode components comprise an anode gas diffusion layer adjacent the anode and an anode flow field plate adjacent the anode gas diffusion layer, the selectively conducting component is the anode flow field plate, and the layer of the selectively conducting material is on the side of the anode flow field plate adjacent the anode gas diffusion layer.

47. The solid polymer electrolyte fuel cell of claim 42 wherein the anode components comprise an anode gas diffusion layer adjacent the anode, and the selectively conducting component is a selectively conducting layer additionally provided in the fuel cell between the anode and the anode gas diffusion layer.

48. The solid polymer electrolyte fuel cell of claim 42 wherein the anode components comprise an anode gas diffusion layer adjacent the anode and an anode flow field plate adjacent the anode gas diffusion layer, and the selectively conducting component is a selectively conducting layer additionally provided in the fuel cell between the anode gas diffusion layer and the anode flow field plate.

49. A method for making the selectively conducting component of claim 30 comprising:
preparing a solid-liquid dispersion of the selectively conductive material;
preparing a layer of the selectively conductive material from the dispersion; and
incorporating the layer of the selectively conductive material into the selectively conducting component.

50. The method of claim 49 comprising coating the dispersion onto a release film and applying the coating on the release film under elevated temperature and pressure to one of the anode, an anode gas diffusion layer, and the anode flow field plate.
